(19) United States
(12) Patent Application Publication
(10) Pub. No.: US 2017/0256990 A1
(43) Pub. Date: Sep. 7, 2017

(54) Receiver Coil Arrangements for Inductive Wireless Power Transfer for Portable Devices

(71) Applicant: Sanjaya Maniktala, Fremont, CA (US)

(72) Inventor: Sanjaya Maniktala, Fremont, CA (US)

(21) Appl. No.: 15/448,196

(22) Filed: Mar. 2, 2017

Related U.S. Application Data
(60) Provisional application No. 62/303,174, filed on Mar. 3, 2016.

(51) Int. Cl. H02J 50/12; H01F 27/24; H01F 27/28; H02J 7/02; H02J 50/40

(52) U.S. Cl. CPC H02J 50/12; H02J 7/025; H02J 50/40; H01F 27/28; H01F 27/24

(57) ABSTRACT

In one embodiment a wireless power receiver system includes a plurality of receiver coil structures, each of the plurality of receiver coil structures including a receiver coil, and a receive circuit coupled to each of the plurality of receiver coil structures, the receive circuit configured to receive a time varying current induced in at least one of the plurality of receiver coil structures and to output a voltage. In one embodiment, the receive circuit includes a plurality of rectifier circuits coupled in parallel, each of the plurality of rectifier circuits coupled to one of the plurality of receiver coil structures. In one embodiment, at least one of the plurality of receiver coil structures includes a ferrite core and a helical coil wrapped around the ferrite core. In one embodiment, at least one of the plurality of receiver coil structures includes a magnetic layer and a coil in the shape of a flat spiral.

### CROSS-REFERENCE TO RELATED APPLICATIONS

This application claims the benefit of U.S. Provisional Patent Application No. 62/303,174, entitled “Receiver Coil Arrangements in Wireless Power Transfer,” filed on Mar. 3, 2016. This application is also related to U.S. patent application Ser. No. 15/082,533, entitled “Wireless Power Transfer Using Multiple Coil Arrays,” filed on Mar. 28, 2016 and U.S. patent application Ser. No. 15/375,499, entitled “System for Inductive Wireless Power Transfer for Portable Devices, filed on Dec. 12, 2016. The subject matters of the related applications are hereby incorporated by reference in their entirety.

### FIELD OF THE INVENTION

This invention relates generally to inductive wireless power transfer and more specifically to receiver coil arrangements for inductive wireless power transfer for portable devices.

### BACKGROUND

Electronic devices typically require a connected (wired) power source to operate, for example, battery power or a wired connection to a direct current (“DC”) or alternating current (“AC”) power source. Similarly, rechargeable battery-powered electronic devices are typically charged using a wired power-supply that connects the electronic device to a DC or AC power source. The limitation of these devices is the need to directly connect the device to a power source using wires.

Wireless power transfer (WPT) involves the use of time-varying magnetic fields to wirelessly transfer power from a source to a device. Faraday's law of magnetic induction provides that if a time-varying current is applied to one coil (e.g., a transmitter coil) a voltage will be induced in a nearby second coil (e.g., a receiver coil). The voltage induced in the receiver coil can then be rectified and filtered to generate a stable DC voltage for powering an electronic device or charging a battery. The receiver coil and associated circuitry for generating a DC voltage can be connected to or included within the electronic device itself such as a smartphone.

The Wireless Power Consortium (WPC) was established in 2008 to develop the Qi inductive power standard for charging and powering electronic devices. Powermat is another well-known standard for WPT developed by the Power Matters Alliance (PMA). The Qi and Powermat near-field standards operate in the frequency band of 100-400 kHz. The problem with near-field WPT technology is that typically only 5 Watts of power can be transferred over the short distance of 2 to 5 millimeters between a power source and an electronic device, though there are ongoing efforts to increase the power. For example, some concurrently developing standards achieve this by operating at much higher frequencies, such as 6.78 MHz or 13.56 MHz. Though they are called magnetic resonance methods instead of magnetic induction, they are based on the same underlying physics of magnetic induction. There also have been some market consolidation efforts to unite into larger organizations, such as the AirFuel Alliance consisting of PMA and the Rezence standard from the Alliance For Wireless Power (A4WP), but the technical aspects have remained largely unchanged.

Some techniques for WPT use two or more transmitter coils in an attempt to overcome the issue of low power transfer over short distances. Typically, two identical transmitter coils (e.g., both wound in the clockwise direction or both wound in the counter-clockwise direction and having the same number of turns and area) are coupled in series or parallel on a single magnetic layer to transfer power to a receiver coil. Alternatively, the coils can be placed in close proximity to one another without the use of a magnetic layer. This configuration results in the applied time-varying current flowing through both coils in the same direction at any point in time, generating an almost perpendicular combined magnetic field with flux lines that flow from both coils in the same direction (i.e., the magnetic field generated by either coil has the same polarity as the other coil). Magnetic flux lines tend to repel if they are in the same direction, which causes the flux lines to radiate through the air for great distances. When magnetic flux lines repel, the magnetic reluctance is high, resulting in a weak magnetic field that reduces the amount of magnetic coupling between the transmitter coils and a receiver coil placed in close proximity (i.e., 2-5 millimeters) to the transmitter coils. So although the coil area is larger than in a single-coil transmitter, the resulting magnetic flux available to transfer power is reduced. If the transmitter coils are placed on separate magnetic layers, an air gap exists between the magnetic layers resulting in an even weaker generated magnetic field as the air gap further increases the reluctance between the transmitter coils.

Due to the short range of existing WPT technology, the transmitter coil must be centered with the receiver coil connected to a device and the coils cannot be more than 2-5 millimeters apart. This makes it difficult to implement wireless power transfer for devices that are not perfectly flat or do not have a large enough area for embedding a typical receiver coil (e.g., Android® wearable devices, Apple® watch, Fitbit® fitness tracker, etc.). The limitations of WPT also affect smartphones if the charging surface with the transmitter coil is not large enough to allow the smartphone device to sit flat on the surface (e.g., in vehicles, which typically do not have a large enough flat surface to accommodate a smartphone device). Thus, the current state of WPT technology is not suitable for many consumer or small industrial devices.

### SUMMARY OF THE INVENTION

In one embodiment, a wireless power receiver system includes a plurality of receiver coil structures, each of the plurality of receiver coil structures including a receiver coil, and a receive circuit coupled to each of the plurality of receiver coil structures, the receive circuit configured to receive a time varying current induced in at least one of the plurality of receiver coil structures and to output a voltage. In one embodiment, the receive circuit includes a plurality of rectifier circuits coupled in parallel, each of the plurality of rectifier circuits coupled to one of the plurality of receiver coil structures. In one embodiment, at least one of the plurality of receiver coil structures includes a ferrite core and a helical coil wrapped around the ferrite core. In one embodiment, at least one of the plurality of receiver coil structures includes a magnetic layer and a coil in the shape of a flat spiral. In one embodiment, the wireless power receiver system includes a charging plug and the receive circuit is configured to output the voltage to the charging plug.

In one embodiment, a wireless power receiver system includes at least one receiver coil structure of a first type, the at least one receiver coil structure of a first type including a ferrite core, and a receiver coil configured such that the ferrite core and the receiver coil share a longitudinal axis, at least one receiver coil structure of a second type, the at least one receiver coil structure of a second type including a magnetic layer, and a receiver coil in the shape of a flat spiral, and a receive circuit coupled to the at least one receiver coil structure of the first type and the at least one receiver coil structure of the second type, the receive circuit configured to receive a time varying current induced in at least one of the at least one receiver coil structure of the first type and the at least one receiver coil structure of the second type and to output a voltage. In one embodiment, the receive circuit comprises at least two rectifier circuits coupled in parallel, one of the at least two rectifier circuits coupled to the at least one receiver coil structure of the first type and one of the at least two rectifier circuits coupled to the at least one receiver coil structure of the second type. In one embodiment, the wireless power receiver system includes a charging plug and the receive circuit is configured to output the voltage to the charging plug.

In one embodiment, a portable electronic device includes a plurality of receiver coil structures, each of the plurality of receiver coil structures comprising a receiver coil, a receive circuit coupled to each of the plurality of receiver coil structures, the receive circuit configured to receive a time varying current induced in at least one of plurality of receiver coils and to output a voltage, and a battery coupled to the receive circuit configured to be charged by the voltage. In one embodiment, the receive circuit includes a plurality of rectifier circuits coupled in parallel, each of the plurality of rectifier circuits coupled to one of the plurality of receiver coil structures. In one embodiment, the portable electronic device includes a housing having a first surface and a second surface, and wherein at least one of the plurality of receiver coil structures is located in proximity to the first surface of the housing and at least another one of the plurality of receiver coil structures is located in proximity to the second surface of the housing.

### BRIEF DESCRIPTION OF THE DRAWINGS

FIG. 1 is a diagram illustrating one embodiment of a wireless power transfer system, according to the present invention.

FIG. 2 is a diagram illustrating one embodiment of a wireless power transfer system, according to the present invention.

FIG. 3 is a diagram illustrating one embodiment of a portable device with a wireless power receiver coil arrangement, according to the present invention.

FIG. 4 is a circuit diagram illustrating one embodiment of a wireless power receiver coil arrangement, according to the present invention.

FIG. 5 is a diagram illustrating one embodiment of a portable device with a wireless power receiver coil arrangement, according to the present invention.

FIG. 6 is a diagram illustrating one embodiment of a portable device with a wireless power receiver coil arrangement, according to the present invention.

FIG. 7 is a diagram illustrating one embodiment of a wearable device with a wireless power receiver coil arrangement, according to the present invention.

FIG. 8 is a diagram illustrating one embodiment of a portable device with a wireless power receiver coil, according to the present invention.

FIG. 9 is a diagram of one embodiment of a jacket for a portable device with a wireless power receiver coil arrangement, according to the present invention.

FIG. 10 is a circuit diagram illustrating one embodiment of a wireless power receiver coil arrangement, according to the present invention.

FIG. 11 is a circuit diagram illustrating one embodiment of a wireless receiver coil arrangement, according to the present invention.

### DETAILED DESCRIPTION

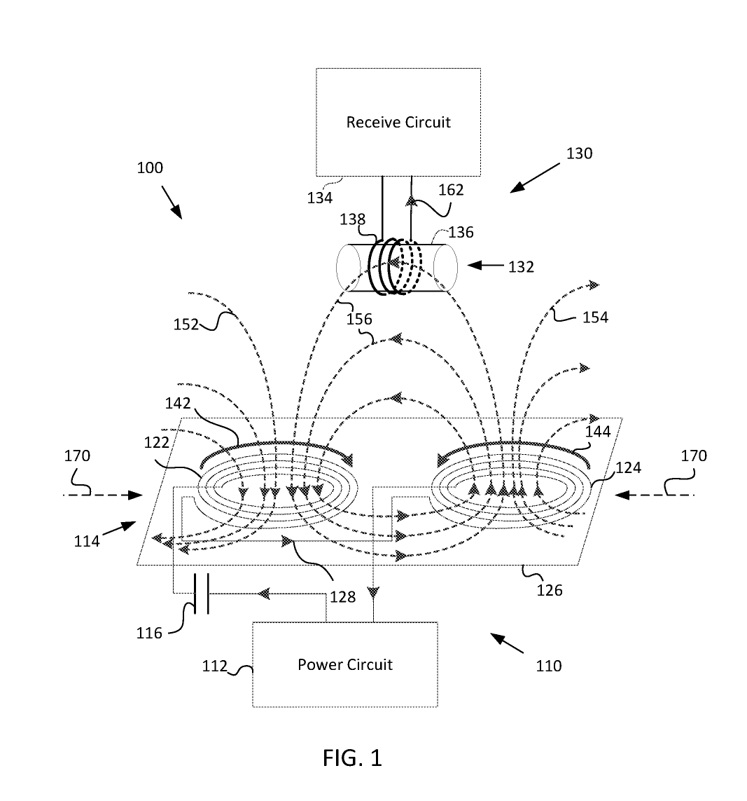

FIG. 1 is a diagram illustrating one embodiment of a wireless power transfer system 100 including a transmitter 110 and a receiver 130. Transmitter 110 includes, but is not limited to, a power circuit 112, a coil structure 114, and a capacitor 116. Coil structure 114 includes, but is not limited to, a coil 122 and a coil 124 that are magnetically coupled together by a magnetic layer 126. Magnetic layer 126 underlies both coil 122 and coil 124. Magnetic layer 126 can be ferrite or any other magnetic layer known in the art. Coil 122 and coil 124 are preferably identical coils with the same number of turns and the same area. Power circuit 112 generates an AC signal having a voltage magnitude consistent with an input DC voltage applied to power circuit 112. The generated AC signal can be, but is not limited to, a square wave, a sinusoidal wave, a triangular wave, or a sawtooth wave. The resonant frequency of transmitter 110 is determined by the capacitance of capacitor 116 and the total inductance of coil 122 and coil 124. The AC signal causes current to flow from power circuit 112 to coil 122 via capacitor 116 and the flow of current through coil 122 generates a magnetic field. The current flows from coil 122 to coil 124. When coils 122 and 124 are identical, the flow of current through coil 124 generates a magnetic field equivalent in magnitude to the magnetic field generated by coil 122. Coils 122 and 124 can be formed of wire or traces on a printed circuit board using conductive material such as copper, gold, or any other conductive material known in the art.

A current 142 flows through coil 122 in the clockwise direction. The clockwise flow of current 142 through coil 122 generates a magnetic field represented by flux lines 152. According to the “right-hand-rule,” the clockwise flow of current 142 through coil 122 causes flux lines 152 to flow in the downward direction. Current 142 flows from coil 122 to coil 124 through a connection 128 (i.e., coil 122 is coupled in series with coil 124). A current 144 flows through coil 124 in the counter-clockwise direction. The counter-clockwise flow of current 144 through coil 124 generates a magnetic field represented by flux lines 154. According to the “right-hand-rule,” the counter-clockwise flow of current 144 through coil 124 causes flux lines 154 to flow in the upward direction.

Current 142 is equivalent in magnitude to current 144 but flows in an opposite direction. If coil 142 and coil 144 are identical, the flow of current 142 through coil 122 generates a magnetic field equivalent in magnitude to the magnetic field generated by the flow of current 144 through coil 124. Because current 142 and current 144 are flowing in opposite directions at any given point in time, the magnetic field generated by current 142 is in a different direction than the magnetic field generated by current 144 (i.e., the magnetic fields have different polarity). Further, because flux lines 152 and flux lines 154 are flowing in opposite directions, the magnetic reluctance between flux lines 152 and flux lines 154 is low, causing flux lines 152 and flux lines 154 to attract to each other. Flux lines 152 and flux lines 154 magnetically couple to form closed flux lines 156. In another embodiment, coil 122 is coupled in parallel with coil 124 such that a current flowing in coil 122 is flowing in an opposite direction to a current flowing in coil 124 to form closed flux lines between coils 122 and 124.

Receiver 130 includes, but is not limited to, a receiver coil structure 132 and a receive circuit 134. Receiver coil structure 132 includes a ferrite core 136 and a helical coil 138. In the FIG. 1 embodiment, ferrite core 136 is in the shape of a cylindrical rod and helical coil 138 is wrapped around ferrite core 136 such that ferrite core 136 and helical coil 138 have a common longitudinal axis. In other embodiments, ferrite core 136 may be a parallelepiped or other shape, or may be made of a flexible ferrite sheet. Helical coil 138 is preferably formed of wire made from a conductive material such as copper, gold, or any other conductive material known in the art. Receiver coil structure 132 is oriented in relation to transmitter coil structure 114 such that flux lines 156 of the magnetic field produced by transmitter 110 pass through ferrite core 136. Receiver coil structure 132 is optimally oriented such that the longitudinal axis of ferrite core 136 is substantially parallel to a longitudinal axis 170 of transmitter coil structure 114. In one embodiment, an outer surface of transmitter coil structure 114 includes a visible marking that indicates longitudinal axis 170. Faraday's law provides that the time-varying current that flows in a receiver coil will oppose the magnetic field generated by a transmitter coil. Thus flux lines 156 passing through ferrite core 136 cause a time-varying current 162 to flow in helical coil 138. Receiver coil structure 132 is coupled to receive circuit 134 such that current 162 is input to receive circuit 134. Receive circuit 134 includes, but is not limited to, a rectifier to generate a DC voltage, a filter to reduce noise, and a voltage regulator to define a voltage magnitude and maintain the voltage under load. The voltage generated by receive circuit 134 as a result of the coupling of flux lines 156 to coil structure 132 can be used to charge a battery or power a device (e.g., a smart phone, laptop or any other electronic device).

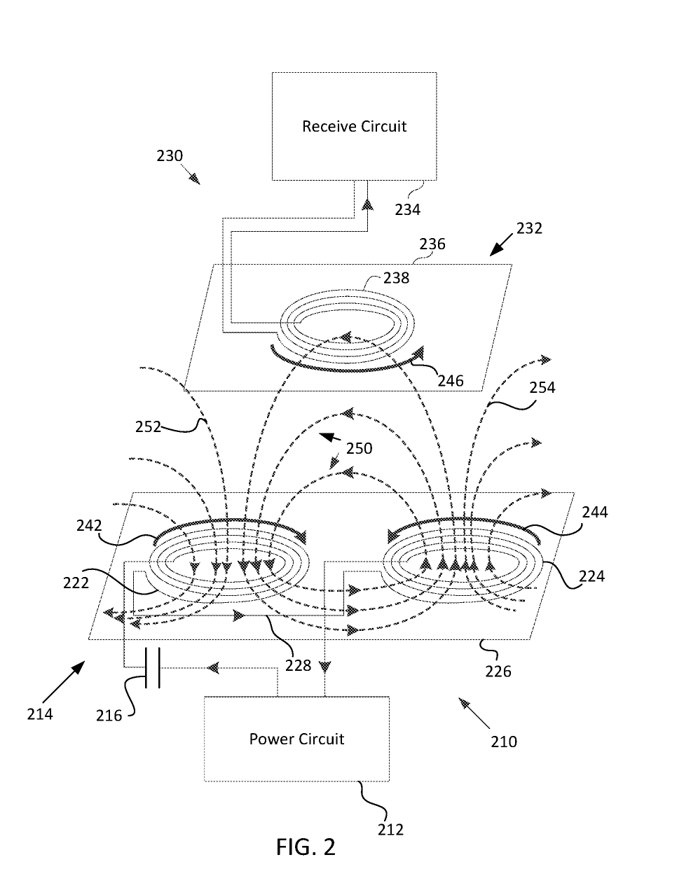

FIG. 2 is a diagram illustrating one embodiment of a wireless power transfer system 200 including a transmitter 210 and a receiver 230. Transmitter 210 includes, but is not limited to, a power circuit 212, a transmitter coil structure 214, and a capacitor 216. Coil structure 214 includes, but is not limited to, a coil 222 and a coil 224 that are magnetically coupled together by a magnetic layer 226. Magnetic layer 226 underlies both coil 222 and coil 224. Magnetic layer 226 can be ferrite or any other magnetic layer known in the art. Coil 222 and coil 224 are preferably identical coils with the same number of turns and the same area. Coil 222 and coil 224 are both wound in the clockwise direction but both coils could alternatively be wound in the counter-clockwise direction. A power circuit 212 generates an AC signal having a voltage magnitude consistent with an input DC voltage applied to power circuit 212. The AC signal can be, but is not limited to, a square wave, a sinusoidal wave, a triangular wave, or a sawtooth wave. The resonant frequency of transmitter 210 is determined by the capacitance of capacitor 216 and the total inductance of coil 222 and coil 224. The AC signal causes current to flow from power circuit 212 to coil 222 via capacitor 216 and the flow of current through coil 222 generates a magnetic field. The current flows from coil 222 to coil 224. When coils 222 and 224 are identical, the flow of current through coil 224 generates a magnetic field equivalent in magnitude to the magnetic field generated by coil 222. Coils 222 and 224 can be formed of wire or traces on a printed circuit board using conductive material such as copper, gold, or any other conductive material known in the art.

A current 242 flows through coil 222 in the clockwise direction. The clockwise flow of current 242 through coil 222 generates a magnetic field represented by flux lines 252. According to the “right-hand-rule,” the clockwise flow of current 242 through coil 222 causes flux lines 252 to flow in the downward direction. Current 242 flows from coil 222 to coil 224 through a connection 228 (i.e., coil 222 is coupled in series with coil 224). A current 244 flows through coil 224 in the counter-clockwise direction. The counter-clockwise flow of current 244 through coil 224 generates a magnetic field represented by flux lines 254. According to the “right-hand-rule,” the counter-clockwise flow of current 244 through coil 224 causes flux lines 254 to flow in the upward direction.

Current 242 is equivalent in magnitude to current 244 but flows in an opposite direction. If coil 222 and coil 224 are identical, the flow of current 242 through coil 222 generates a magnetic field equivalent in magnitude to the magnetic field generated by the flow of current 244 through coil 224. Because current 242 and current 244 are flowing in opposite directions at any given point in time, the magnetic field generated by current 242 is in a different direction than the magnetic field generated by current 244 (i.e., the magnetic fields have different polarity). Further, because flux lines 252 and flux lines 254 are flowing in opposite directions, the magnetic reluctance between flux lines 252 and flux lines 254 is low, causing flux lines 252 and flux lines 254 to attract to each other. Flux lines 252 and flux lines 254 magnetically couple to form closed flux lines 250. In another embodiment, coil 222 is coupled in parallel with coil 224 such that a current flowing in coil 222 is flowing in an opposite direction to a current flowing in coil 224 to form closed flux lines between coils 222 and 224.

Receiver 230 includes, but is not limited to, a receive circuit 234 and a receiver coil structure 232. Receiver coil structure 232 includes a magnetic layer 236 and a coil 238. In the FIG. 2 embodiment, coil 238 is a spiral coil in contact with magnetic layer 236. Coil 238 is preferably formed of wire made from a conductive material such as copper, gold, or any other conductive material known in the art. Receiver coil structure 232 is oriented in relation to transmitter coil structure 214 such that flux lines 250 of the magnetic field produced by transmitter 210 pass through receiver coil structure 232. Faraday's law provides that the time-varying current that flows in a receiver coil will oppose the magnetic field generated by a transmitter coil. Thus flux lines 250 passing through receiver coil structure 232 cause a time-varying current 246 to flow in coil 238. Receiver coil structure 232 is coupled to receive circuit 234 such that current 242 is input to receive circuit 234. Receive circuit 234 includes, but is not limited to, a rectifier to generate a DC voltage, a filter to reduce noise, and a voltage regulator to define a voltage magnitude and maintain the voltage under load. The voltage generated by receive circuit 234 as a result of the concentration of flux lines 250 through receiver coil structure 232 can be used to charge a battery or power a device.

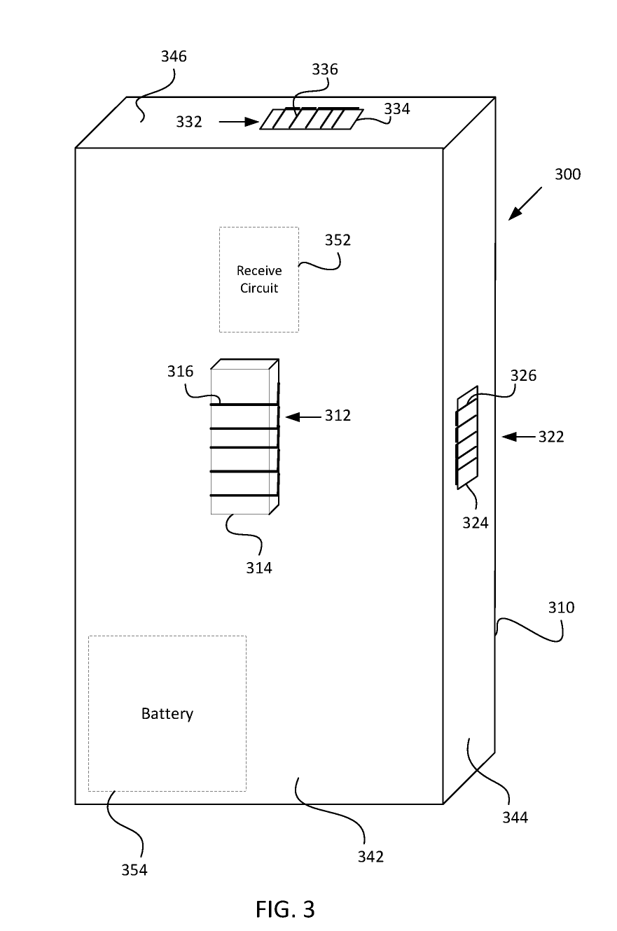

FIG. 3 is a diagram illustrating one embodiment of a portable device 300 with a wireless power receiver coil arrangement including a plurality of receiver coil structures, according to the present invention. Portable device 300 may be any type of electronic device powered by a battery, for example a smartphone, a tablet, an e-reader, a camera, or a toy. Portable device 300 includes but is not limited to a housing 310, a receiver coil structure 312, a receiver coil structure 322, a receiver coil structure 332, a receive circuit 352, and a battery 354. Housing 310 may be formed of plastic, metal, or a combination of materials. Receiver coil structure 312 is preferably located beneath a first surface 342 of housing 310, receiver coil structure 322 is preferably located beneath a second surface 344 of housing 310, and receiver coil structure 332 is preferably located beneath a third surface 346 of housing 310. In other embodiments, one or more of receiver coil structures 312, 322, and 332 is incorporated within housing 310. In other embodiments, one or more of receiver coil structures 312, 322, and 332 is attached to the outside of housing 310. Each of receiver coil structures 312, 322, and 332 is coupled to receive circuit 352. Receive circuit 352 includes, but is not limited to, one or more rectifier circuits to generate a DC voltage, a filter to reduce noise, and a voltage regulator to define a voltage magnitude and maintain the voltage under load. Receive circuit 352 outputs the generated voltage to battery 354.

Receiver coil structure 312 includes a ferrite core 314 and a coil 316, and coil 316 winds around ferrite core 314 such that ferrite core 314 and coil 316 share a longitudinal axis. Receiver coil structure 322 includes a ferrite core 324 and a coil 326, and coil 326 winds around ferrite core 324 such that ferrite core 324 and coil 326 share a longitudinal axis. Receiver coil structure 332 includes a ferrite core 334 and a coil 336, and coil 336 winds around ferrite core 334 such that ferrite core 334 and coil 336 share a longitudinal axis. In the FIG. 3 embodiment, each of ferrite cores 314, 324, and 334 is in the shape of a parallelepiped; however other shapes are within the scope of the invention. Each of coil 316, 326, and 336 is preferably formed of wire made from a conductive material such as copper, gold, or any other conductive material known in the art. Portable device 300 can be placed on a surface of a transmitter such as transmitter 110 or 210 such that at least one of receiver coil structures 312, 322, and 332 receives magnetic flux and generates a time varying current that is provided to receive circuit 352. For example, first surface 342 of portable device 310 can be placed in contact with a surface of a transmitter such as transmitter 110 or 210 such that receiver coil structure 312 receives magnetic flux from the transmitter. During power transfer, portable device 300 is preferably oriented with respect to the transmitter such that the longitudinal axis of at least one of receiver coil structures 312, 322, and 332 is substantially parallel to a longitudinal axis of the transmitter's coil structure.

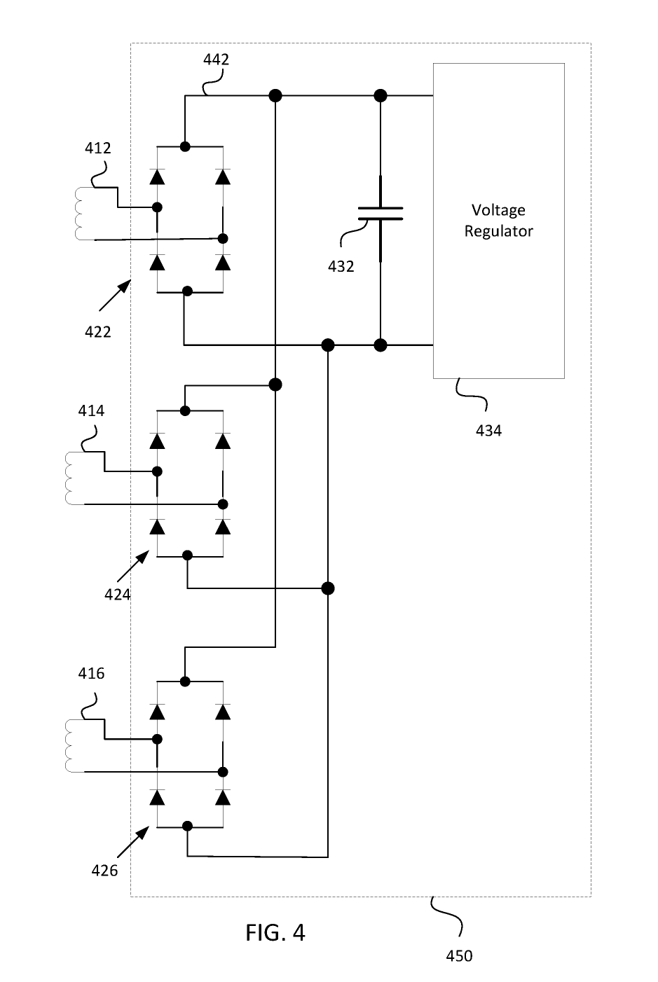

FIG. 4 is a circuit diagram illustrating one embodiment of a wireless power receiver coil arrangement including a plurality of receiver coil circuits, according to the present invention. A receiver coil circuit 412, a receiver coil circuit 414, and a receiver coil circuit 416 are coupled to a receive circuit 450. Receiver coil circuit 412 is coupled to a rectifier bridge 422. When an induced current is flowing in receiver coil structure 412 the current is input to rectifier bridge 422, which rectifies the signal and outputs the rectified signal at a line 442. Receiver coil circuit 414 is coupled to a rectifier bridge 424. When an induced current is flowing in receiver coil circuit 414 the current is input to rectifier bridge 424, which rectifies the signal and outputs the rectified signal at line 442. Receiver coil circuit 416 is coupled to a rectifier bridge 426. When an induced current is flowing in receiver coil circuit 416 the current is input to rectifier bridge 426, which rectifies the signal and outputs the rectified signal at line 442. Rectifier bridge 422, rectifier bridge 424, and rectifier bridge 426 are coupled in parallel to each other, a capacitor 432, and a voltage regulator 434. Capacitor 432 filters the signal at line 442 to reduce noise, and voltage regulator 434 defines an output voltage magnitude and maintains the voltage under load.

In one embodiment, each of receiver coil circuits 412, 414, and 416 represents a receiver coil structure within a portable device. Rectifier bridges 422, 424, and 426 jointly operate similar to a logic OR circuit (known as “diode ORing”) such that when one of the receiver coil circuits, for example receiver coil circuit 414, generates a voltage larger than a voltage of either of the other receiver coil circuits 412 and 416 the voltage generated by receiver coil circuit 414 will be seen by capacitor 432 and voltage regulator 434. If a voltage produced by receiver coil circuit 414 dominates, that voltage forward biases rectifier bridge 424 and reverse biases the diodes in rectifier bridges 422 and 426 so that no energy is drawn from receiver coil circuits 412 and 416. In one embodiment, receiver coil circuit 412 is disposed at a first surface of a portable device, receiver coil circuit 414 is disposed at a second surface of the portable device, and receiver coil circuit 416 is disposed at a third surface of the portable device. If the first surface of the portable device is placed on a surface of a wireless power transmitter such as transmitter 110 or 210, receiver coil circuit 412 will receive magnetic flux from the transmitter, which causes a time varying current to flow in receiver coil circuit 412. If the second surface of the portable device is placed on a surface of a wireless power transmitter such as transmitter 110 or 210, receiver coil circuit 414 will receive magnetic flux from the transmitter, which causes a time varying current to flow in receiver coil circuit 414. If the third surface of the portable device is placed on a surface of a wireless power transmitter such as transmitter 110 or 210, receiver coil circuit 416 will receive magnetic flux from the transmitter, which causes a time varying current to flow in receiver coil circuit 416. In one embodiment, more than one of receiver coil circuits 412, 414, 416 may receive magnetic flux from a wireless power transmitter. In such a case, whichever one of receiver coil circuits 412, 414, 416 that receives the largest amount of magnetic flux from the transmitter will produce a voltage that will be seen by capacitor 432 and voltage regulator 434.

In another embodiment, one or more of rectifier bridges 422, 424, and 426 is replaced with a rectifier bridge including four MOSFETs (metal oxide semiconductor field-effect transistors), which is sometimes called an “active bridge” or “synchronous bridge.” A MOSFET in an active bridge is turned on (i.e., conducting) by a control circuit when its body diode begins to conduct, and is turned off (i.e., non-conducting) by the control circuit when its body diode becomes or is about to become reverse-biased. In this embodiment, the forward voltage drop across the body diode of each conducting MOSFET is smaller than the forward voltage drop across a typical diode because of the relatively low resistance of a conducting MOSFET. In another embodiment, each of the four MOSFETs in an active bridge is configured to be non-conducting such that its body diode dictates its operation.

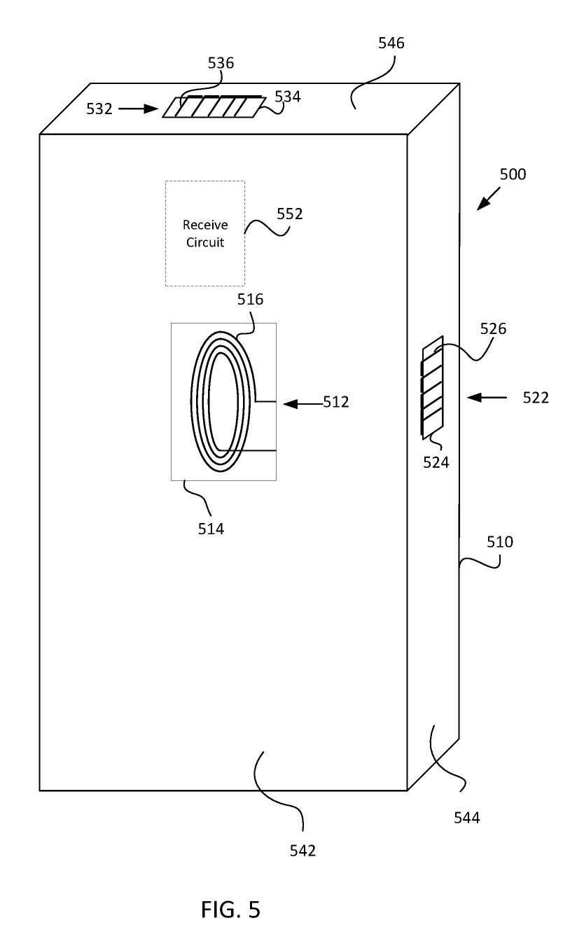

FIG. 5 is a diagram illustrating one embodiment of a portable device 500 with a wireless power receiver coil arrangement, according to the present invention. Portable device 500 may be any type of electronic device powered by a battery (not shown), for example a smartphone, a tablet, an e-reader, a camera, or a toy. Portable device 500 includes but is not limited to a housing 510, a receiver coil structure 512, a receiver coil structure 522, a receiver coil structure 532, and a receive circuit 552. Housing 510 may be formed of plastic, metal, or a combination of materials. Receiver coil structure 512 is preferably located beneath a first surface 542 of housing 510, receiver coil structure 522 is preferably located beneath a second surface 544 of housing 510, and receiver coil structure 532 is preferably located beneath a third surface 546 of housing 510. In other embodiments, one or more of receiver coil structures 512, 522, and 532 can be attached to the outside of housing 510. Each of receiver coil structures 512, 522, and 532 is coupled to receive circuit 552. Receive circuit 552 includes, but is not limited to, one or more rectifiers to generate a DC voltage, a filter to reduce noise, and a voltage regulator to define a voltage magnitude and maintain the voltage under load.

Receiver coil structure 512 includes a magnetic layer 514 and a spiral coil 516. Receiver coil structure 522 includes a ferrite core 524 and a coil 526, and coil 526 winds around ferrite core 524 such that ferrite core 524 and coil 526 share a longitudinal axis. Receiver coil structure 532 includes a ferrite core 534 and a coil 536, and coil 536 winds around ferrite core 534 such that ferrite core 534 and coil 536 share a longitudinal axis. In the FIG. 5 embodiment, each of ferrite cores 524 and 534 is in the shape of a parallelepiped. Each of coil 516, 526, and 536 is preferably formed of wire made from a conductive material such as copper, gold, or any other conductive material known in the art. Portable device 500 can be placed on a surface of a transmitter such as transmitter 110 or 210 such that at least one of receiver coil structures 512, 522, and 532 receives magnetic flux and generates a time varying current that is provided to receive circuit 552. For example, first surface 542 of portable device 500 is placed in contact with a surface of a transmitter such as transmitter 110 or 210 such that receiver coil structure 512 receives magnetic flux from the transmitter. In another example, second surface 544 of portable device 500 is placed on a surface of the transmitter such that receiver coil structure 522 receives magnetic flux from the transmitter. During power transfer using receiver coil structure 522 or 532, portable device 500 is preferably oriented with respect to the transmitter such that the longitudinal axis of receiver coil structure 522 or 532 is substantially parallel to a longitudinal axis of the transmitter's coil structure.

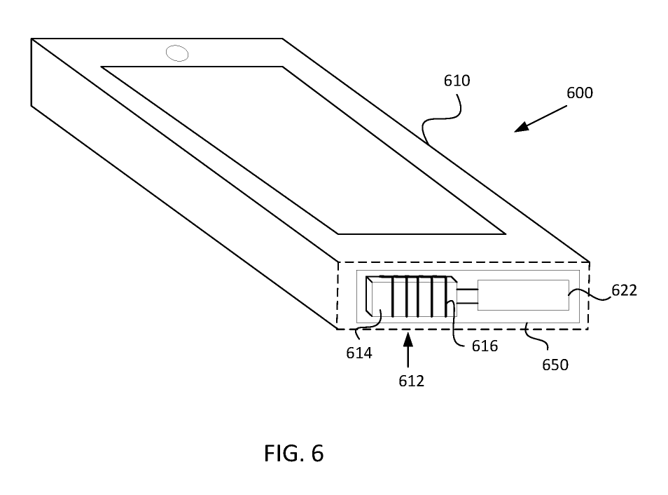

FIG. 6 is a diagram illustrating one embodiment of a portable device 600 with a wireless power receiver module 650. Portable device 600 may be any type of electronic device powered by a battery (not shown), for example a smartphone, a tablet, a camera, or a toy. Portable device 600 includes, but is not limited to, a housing 610 and a wireless power receiver module 650. Wireless power receiver module 650 includes a receiver coil structure 612 and a receive circuit 622 coupled to receiver coil structure 612 to rectify and filter received energy into a voltage and charge the battery. Housing 610 may be formed of plastic, metal, or a combination of materials. Receiver coil module 650 is preferably located within housing 610 of portable device 600. Receiver coil structure 612 includes a ferrite core 614 and a coil 616. In the FIG. 6 embodiment, ferrite core 614 is in the shape of a parallelepiped and coil 616 winds around ferrite core 614 such that ferrite core 614 and coil 616 share a longitudinal axis. Coil 616 is preferably formed of wire made from a conductive material such as copper, gold, or any other conductive material known in the art. Portable device 600 can be placed on a surface of a transmitter such as transmitter 110 or 210 such that receiver coil structure 612 receives magnetic flux and generates a time varying current that is provided to receive circuit 622. During power transfer, mobile device 600 is preferably oriented with respect to the transmitter such that the longitudinal axis of receiver coil structure 612 is substantially parallel to a longitudinal axis of the transmitter's coil structure. Although only a single receiver module 650 is shown in FIG. 6, portable device 600 may include two or more receiver modules 650 located at different sides of housing 610.

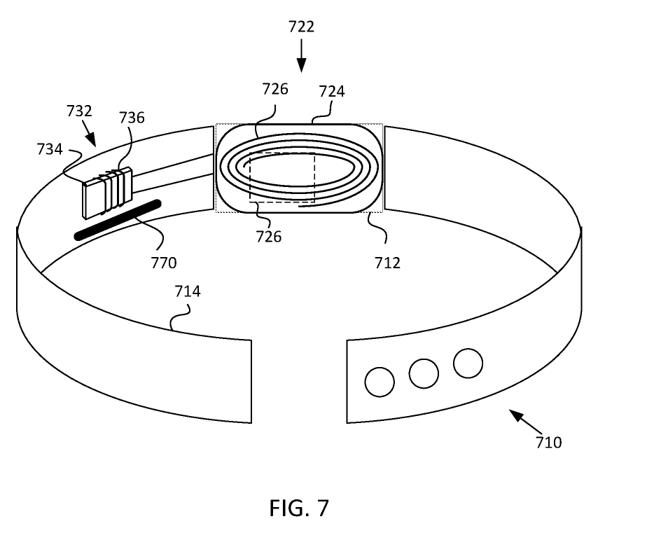

FIG. 7 is a diagram illustrating one embodiment of a wearable device 710 with a wireless power receiver coil arrangement including a receiver coil structure 732 and a receiver coil structure 724. Wearable device 710 includes but is not limited to a strap 714, an electronic device 712, receiver coil structure 722, and receiver coil structure 732. In other embodiments, wearable device 710 may be embodied as a headset, eyewear (e.g., 3-D glasses), or clothing. Electronic device 712 may be, for example, a fitness tracker, a pedometer, a heartrate monitor, a watch, a mobile telephone, or a computer and includes a rechargeable battery (not shown). Electronic device 712 includes a receive circuit 716 coupled to receiver coil structure 722 and receiver coil structure 732 to rectify and filter received energy into a voltage and charge the battery. Electronic device 712 has a housing that may be formed of plastic, metal, or a combination of materials. Receiver coil structure 732 includes a ferrite core 734 and a coil 736. In the FIG. 7 embodiment, ferrite core 734 is in the shape of a parallelepiped and coil 736 winds around ferrite core 734 such that ferrite core 734 and coil 736 share a longitudinal axis. Ferrite core 734 is formed of a flexible ferrite material that can flex in concert with strap 714. Receiver coil structure 732 can be attached to an outer surface of strap 714 or embedded within strap 714. Receiver coil structure 722 includes a magnetic layer 724 and a spiral coil 726. In one embodiment, magnetic layer 724 is a portion of the housing of electronic device 712.

Wearable device 710 can be placed on a surface of a transmitter such as transmitter 110 or 210 such that receiver coil structure 732 receives magnetic flux and generates a time varying current that is provided to receive circuit 716. Wearable device 710 optionally includes a visible marking 770 on the surface of strap 714 that indicates the longitudinal axis of receiver coil structure 732. Wearable device 710 can also be placed on a surface of a transmitter, such as transmitter 110 or 210 or another type of wireless power transmitter, such that receiver coil structure 722 receives magnetic flux and generates a time varying current that is provided to receive circuit 716.

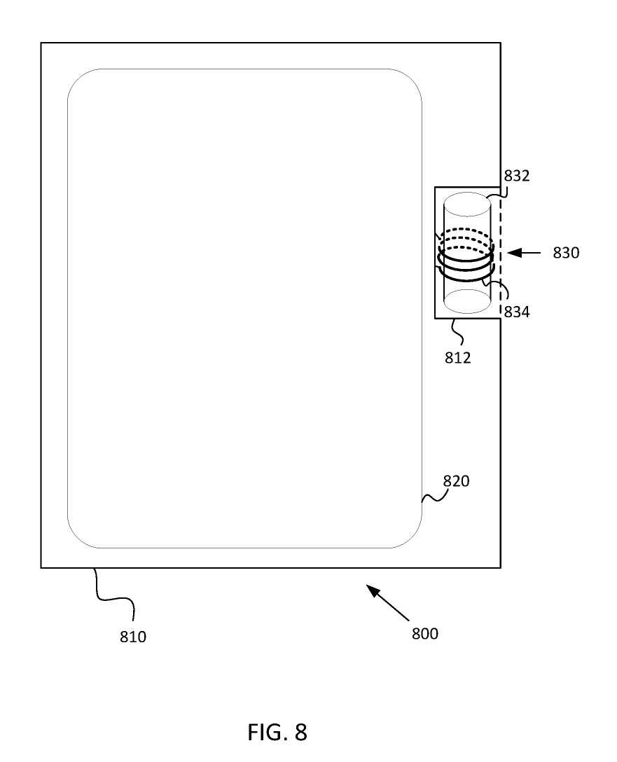

FIG. 8 is a diagram illustrating one embodiment of a portable device 800 with a wireless power receiver coil structure, according to the present invention. Portable device 800 may be any type of electronic device powered by a battery (not shown), for example a smartphone, a tablet, an e-reader, or a toy. Portable device 800 includes but is not limited to a housing 810, a display screen 820, and a receiver coil structure 830. Housing 810 includes a cavity 812 that houses receiver coil structure 830. Receiver coil structure 830 includes a ferrite core 832 and a coil 834. In the FIG. 8 embodiment, ferrite core 832 is in the shape of a cylinder and coil 834 winds around ferrite core 832 such that ferrite core 832 and coil 834 share a longitudinal axis. Coil 834 is coupled to a receive circuit (not shown) that is configured to rectify and filter received energy into a voltage and charge the battery. Portable device 800 can be placed on a surface of a transmitter, such as transmitter 110 or 210, such that receiver coil structure 830 receives magnetic flux and generates a time varying current that is provided to the receive circuit. Although only one cavity 812 is shown in FIG. 8, any number of cavities in housing 810 housing receiver coil structures is within the scope of the invention.

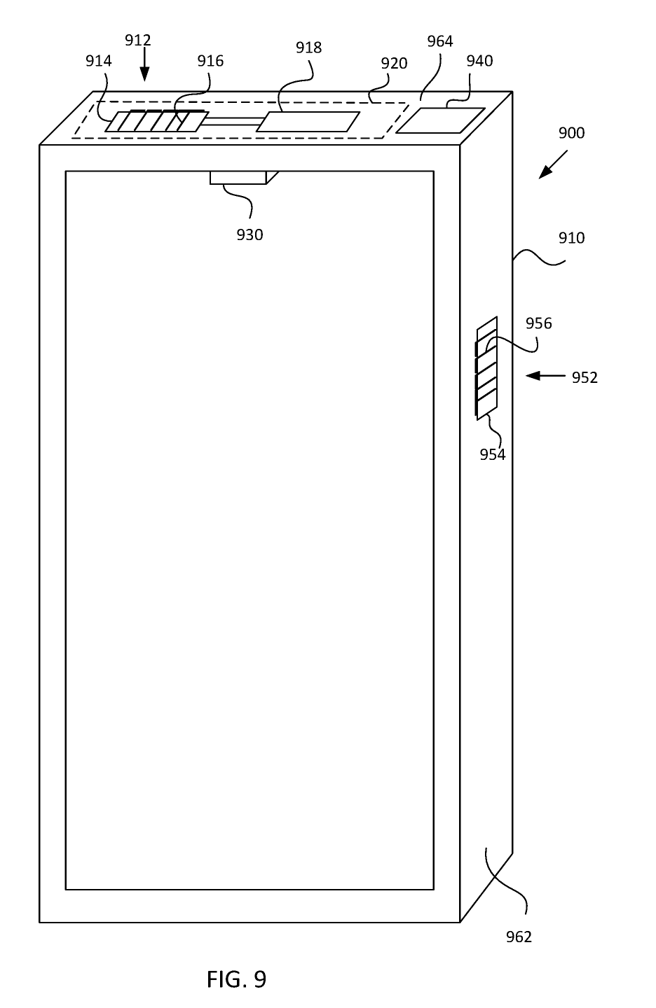

FIG. 9 is a diagram of one embodiment of a jacket 900 for a portable device with a wireless power receiver coil arrangement, according to the present invention. Jacket 900 includes, but is not limited to a jacket body 910, a receiver coil structure 912, a receiver coil structure 952, a receive circuit 918, a plug 930, and a port 940. Receiver coil structure 912 includes a ferrite core 914 and a coil 916, and coil 916 winds around ferrite core 914 such that ferrite core 914 and coil 916 share a longitudinal axis. Receiver coil structure 952 includes a ferrite core 954 and a coil 956, and coil 956 winds around ferrite core 954 such that ferrite core 954 and coil 956 share a longitudinal axis. In the FIG. 9 embodiment, each of ferrite cores 914 and 916 is in the shape of a parallelepiped; however other shapes are within the scope of the invention. Each of coil 916 and 956 is preferably formed of wire made from a conductive material such as copper, gold, or any other conductive material known in the art. Each of receiver coil structures 912 and 952 is coupled to receive circuit 918. Receive circuit 918 includes, but is not limited to, one or more rectifiers to generate a DC voltage, a filter to reduce noise, and a voltage regulator to define a voltage magnitude and maintain the voltage under load.

Jacket body 910 is configured to fit around the outer surfaces of a portable device such as a tablet, smartphone, or e-reader. Plug 930 is configured to be plugged directly into a charging and/or data port (socket) of the portable device. In one embodiment, plug 930 conforms to a USB standard such as USB 2.0, USB 3.0, mini-USB, micro-USB, or USB-C. In other embodiments, plug 930 conforms to a Lightning connection standard or other standard for providing power to portable devices. Receive circuit 918 is coupled to plug 930 such that a voltage output by receive circuit 918 is provided to plug 930. Port 940 is configured to receive a charging and/or data plug of an external device. Port 940 is coupled to plug 930 such that data or power provided to port 940 is output by plug 930. Jacket 900 can be placed on a surface of a transmitter, such as transmitter 110 or 210, such that receiver coil structure 912 or receiver coil structure 952 receives magnetic flux and generates a time varying current that is provided to receive circuit 918. Receive circuit 918 generates a voltage that is output to plug 930.

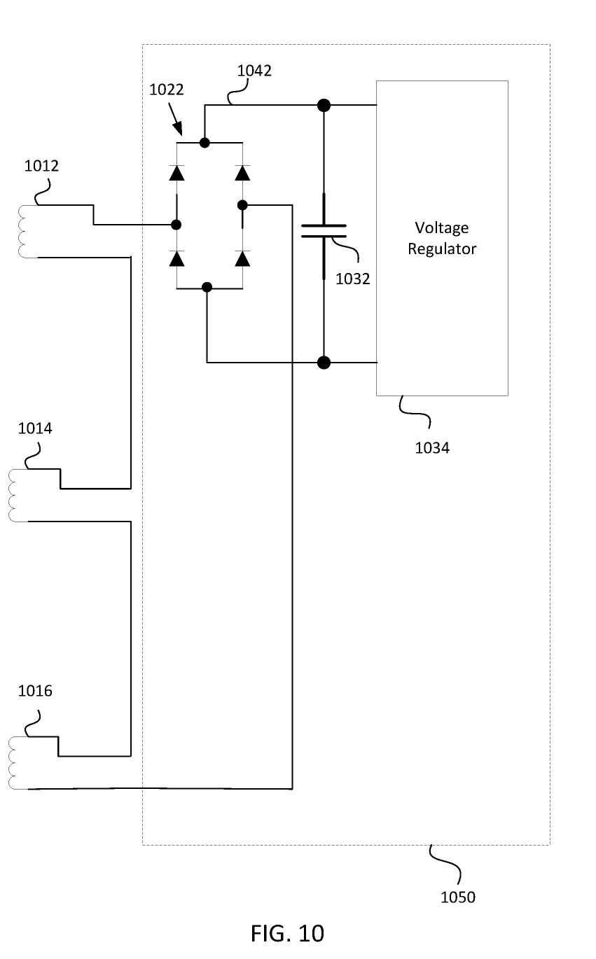

FIG. 10 is a circuit diagram illustrating one embodiment of a wireless power receiver coil arrangement, according to the present invention. A receiver coil circuit 1012, a receiver coil circuit 1014, and a receiver coil circuit 1016 are coupled together in series. Receiver coil circuit 1012 and receiver coil circuit 1016 are also coupled to a rectifier bridge 1022 in a receive circuit 1050. When an induced current is flowing in receiver coil structure 412 the current is input to rectifier bridge 1022, which rectifies the signal and outputs the rectified signal at a line 1042. When an induced current is flowing in receiver coil circuit 1014 the current is input to rectifier bridge 1022, which rectifies the signal and outputs the rectified signal at line 1042. When an induced current is flowing in receiver coil circuit 1016 the current is input to rectifier bridge 1022, which rectifies the signal and outputs the rectified signal at line 1042. Rectifier bridge 1022 is coupled to a capacitor 1032 and a voltage regulator 1034. Capacitor 1032 filters the signal at line 1042 to reduce noise, and voltage regulator 1034 defines an output voltage magnitude and maintains the voltage under load.

In one embodiment, each of receiver coil circuits 1012, 1014, and 1016 represents a receiver coil structure within a portable device. In one embodiment, receiver coil circuit 1012 is disposed at a first surface of a portable device, receiver coil circuit 1014 is disposed at a second surface of the portable device, and receiver coil circuit 1016 is disposed at a third surface of the portable device. If the first surface of the portable device is placed on a surface of a wireless power transmitter such as transmitter 110 or 210, receiver coil circuit 1012 will receive magnetic flux from the transmitter, which causes a time varying current to flow in receiver coil circuit 1012. If the second surface of the portable device is placed on a surface of a wireless power transmitter such as transmitter 110 or 210, receiver coil circuit 1014 will receive magnetic flux from the transmitter, which causes a time varying current to flow in receiver coil circuit 1014. If the third surface of the portable device is placed on a surface of a wireless power transmitter such as transmitter 110 or 210, receiver coil circuit 1016 will receive magnetic flux from the transmitter, which causes a time varying current to flow in receiver coil circuit 1016. In one embodiment, more than one of receiver coil circuits 1012, 1014, 1016 may receive magnetic flux from a wireless power transmitter. In such a case, each of receiver coil circuits 1012, 1014, 1016 that receives magnetic flux from the transmitter will contribute to a voltage that will be seen by capacitor 1032 and voltage regulator 1034.

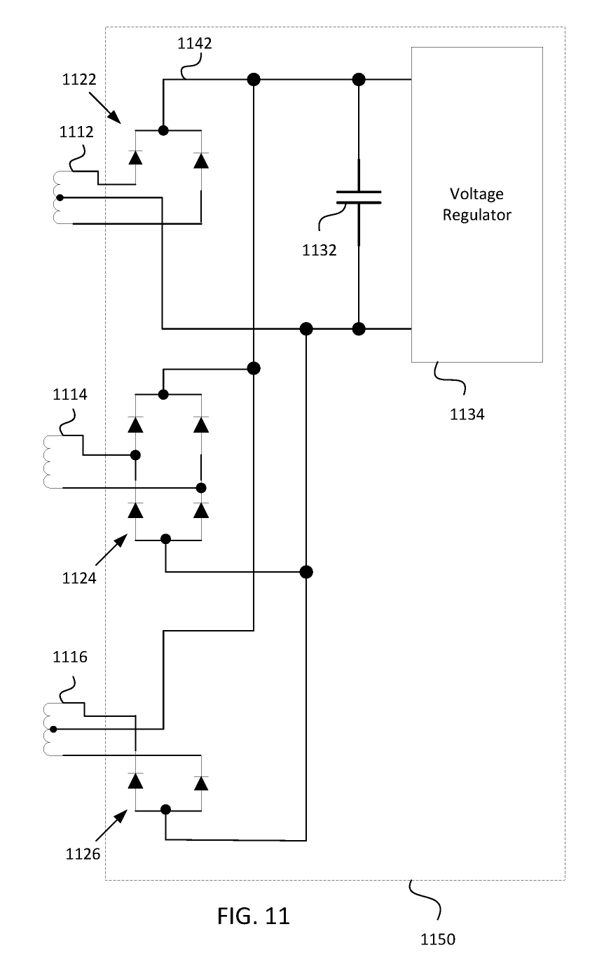

FIG. 11 is a circuit diagram illustrating one embodiment of a wireless receiver coil arrangement, according to the present invention. A receiver coil circuit 1112, a receiver coil circuit 1114, and a receiver coil circuit 1116 are coupled to a receive circuit 1150. Receiver coil circuit 1112 includes a center-tapped coil that is coupled to a rectifier bridge 1122. In the FIG. 11 embodiment, rectifier bridge 1122 is a high side half-bridge that includes two diodes. When an induced current is flowing in receiver coil structure 1112 the current is input to rectifier bridge 1122, which rectifies the signal and outputs the rectified signal at a line 1142. Receiver coil circuit 1114 is coupled to a rectifier bridge 1124. When an induced current is flowing in receiver coil circuit 1114 the current is input to rectifier bridge 1124, which rectifies the signal and outputs the rectified signal at line 1142. Receiver coil circuit 1116 includes a center-tapped coil that is coupled to a rectifier bridge 1126. In the FIG. 11 embodiment, rectifier bridge 1126 is a low side half-bridge including two diodes. When an induced current is flowing in receiver coil circuit 1116 the current is input to rectifier bridge 1126, which rectifies the signal and outputs the rectified signal at line 1142. Each of rectifier bridge 1122, rectifier bridge 1124, and rectifier bridge 1126 is coupled to a capacitor 1132 and a voltage regulator 1134. Capacitor 1132 filters the signal at line 1142 to reduce noise, and voltage regulator 1134 defines an output voltage magnitude and maintains the voltage under load.

In one embodiment, each of receiver coil circuits 1112, 1114, and 1116 represents a receiver coil structure within a portable device. Rectifier bridges 1122, 1124, and 1126 jointly operate similar to a logic OR circuit (known as “diode ORing”) such that when one of the receiver coil circuits, for example receiver coil circuit 1112, generates a voltage larger than a voltage of either of the other receiver coil circuits 1114 and 1116 the voltage generated by receiver coil circuit 1112 will be seen by capacitor 1132 and voltage regulator 1134. If a voltage produced by receiver coil circuit 1112 dominates, that voltage forward biases rectifier bridge 1122 and reverse biases the diodes in rectifier bridges 1124 and 1126 so that no energy is drawn from receiver coil circuits 1114 and 1116. In one embodiment, receiver coil circuit 1112 is disposed at a first surface of a portable device, receiver coil circuit 1114 is disposed at a second surface of the portable device, and receiver coil circuit 1116 is disposed at a third surface of the portable device. If the first surface of the portable device is placed on a surface of a wireless power transmitter such as transmitter 110 or 210, receiver coil circuit 1112 will receive magnetic flux from the transmitter, which causes a time varying current to flow in receiver coil circuit 1112. If the second surface of the portable device is placed on a surface of a wireless power transmitter such as transmitter 110 or 210, receiver coil circuit 1114 will receive magnetic flux from the transmitter, which causes a time varying current to flow in receiver coil circuit 1114. If the third surface of the portable device is placed on a surface of a wireless power transmitter such as transmitter 110 or 210, receiver coil circuit 1116 will receive magnetic flux from the transmitter, which causes a time varying current to flow in receiver coil circuit 1116. In one embodiment, more than one of receiver coil circuits 1112, 1114, 1116 may receive magnetic flux from a wireless power transmitter. In such a case, whichever one of receiver coil circuits 1112, 1114, 1116 that receives the largest amount of magnetic flux from the transmitter will produce a voltage that will be seen by capacitor 1132 and voltage regulator 1134.

Receiver coil arrangements including a plurality of receiver coil structures such as those shown in FIGS. 3, 5, 6, 7, 8, and 9 may also be used to provide power to other types of devices with or without a rechargeable battery including, but not limited to, medical implants, medical point-of-care equipment, vacuum cleaners, tablets, laptops, smartphones, two-way radios, toys, virtual reality glasses and headsets, cameras, portable tools, lighting, remote controls, emergency lamps, gaming stations, electric vehicle charging, in-cabin car charging, robots, and unmanned aerial vehicles (drones).

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A wireless power receiver system comprising:
a plurality of receiver coil structures, each of the plurality of receiver coil structures including a receiver coil; and
a receive circuit coupled to each of the plurality of receiver coil structures, the receive circuit configured to receive a time varying current induced in at least one of the plurality of receiver coil structures and to output a voltage.

2. The wireless power receiver system of claim 1, wherein the receive circuit comprises a plurality of rectifier circuits coupled in parallel, each of the plurality of rectifier circuits coupled to one of the plurality of receiver coil structures.

3. The wireless power receiver system of claim 1, wherein at least one of the plurality of receiver coil structures comprises a ferrite core and the receiver coil is a helical coil that wraps around the ferrite core such that the ferrite core and the receiver coil substantially share a longitudinal axis.

4. The wireless power receiver system of claim 3, wherein the ferrite core is made of a flexible ferrite material.

5. The wireless power receiver system of claim 1, wherein at least one of the plurality of receiver coil structures comprises a magnetic layer and a receiver coil that is in the shape of a flat spiral.

6. The wireless power receiver system of claim 1, wherein the receive circuit is configured to output the voltage to a rechargeable battery.

7. The wireless power receiver system of claim 1, further comprising a charging plug and wherein the receive circuit is configured to output the voltage to the charging plug.

8. A wireless power receiver system comprising:
at least one receiver coil structure of a first type, the at least one receiver coil structure of a first type comprising
a ferrite core, and
a receiver coil configured such that the ferrite core and the receiver coil share a longitudinal axis;
at least one receiver coil structure of a second type, the at least one receiver coil structure of a second type comprising
a magnetic layer, and
a receiver coil in the shape of a flat spiral; and
a receive circuit coupled to the at least one receiver coil structure of the first type and the at least one receiver coil structure of the second type, the receive circuit configured to receive a time varying current induced in at least one of the at least one receiver coil structure of the first type and the at least one receiver coil structure of the second type and to output a voltage.

9. The wireless power receiver system of claim 8, wherein the receive circuit comprises at least two rectifier circuits coupled in parallel, one of the at least two rectifier circuits coupled to the at least one receiver coil structure of the first type and one of the at least two rectifier circuits coupled to the at least one receiver coil structure of the second type.

10. The wireless power receiver system of claim 8, wherein the ferrite core is made of a flexible ferrite material.

11. The wireless power receiver system of claim 8, wherein the receive circuit is configured to output the voltage to a rechargeable battery.

12. The wireless power receiver system of claim 8, further comprising a charging plug and wherein the receive circuit is configured to output the voltage to the charging plug.

13. An electronic device comprising:
a plurality of receiver coil structures, each of the plurality of receiver coil structures comprising a receiver coil;
a receive circuit coupled to each of the plurality of receiver coil structures, the receive circuit configured to receive a time varying current induced in at least one of plurality of receiver coils and to output a voltage; and
a battery coupled to the receive circuit configured to be charged by the voltage.

14. The electronic device of claim 13, wherein the receive circuit comprises a plurality of rectifier circuits coupled in parallel, each of the plurality of rectifier circuits coupled to one of the plurality of receiver coil structures.

15. The electronic device of claim 13, wherein at least one of the plurality of receiver coil structures comprises a ferrite core and the receiver coil is a helical coil that wraps around the ferrite core such that the ferrite core and the receiver coil substantially share a longitudinal axis.

16. The wireless power receiver system of claim 15, wherein the ferrite core is made of a flexible ferrite material.

17. The electronic device of claim 13, wherein at least one of the plurality of receiver coil structures comprises a magnetic layer and a receiver coil that is in the shape of a flat spiral.

18. The electronic device of claim 13, further comprising a housing having a first surface and a second surface, and wherein at least one of the plurality of receiver coil structures is located in proximity to the first surface of the housing and at least another one of the plurality of receiver coil structures is located in proximity to the second surface of the housing.

19. The electronic device of claim 13, further comprising a housing including a cavity, wherein at least one of the plurality of receiver coil structures is disposed within the cavity of the housing.

20. The electronic device of claim 13, further comprising a strap and wherein at least one of the plurality of receiver coil structures is embedded in the strap.
